(19) United States
(12) Patent Application Publication
(10) Pub. No.: US 2025/0301445 A1
(43) Pub. Date: Sep. 25, 2025

(54) METHOD FOR TRACKING AND RECALIBRATING QUANTITIES OF OBJECTS WITHIN A SPACE

(71) Applicant: VergeSense, Inc., San Francisco, CA (US)

(72) Inventors: Kelby Green, San Francisco, CA (US); Andrew Robbins, San Francisco, CA (US); Timothy Crocker, San Francisco, CA (US)

(21) Appl. No.: 19/085,778

(22) Filed: Mar. 20, 2025

Related U.S. Application Data
(60) Provisional application No. 63/567,682, filed on Mar. 20, 2024.

(51) Int. Cl. H04W 64/00; H04L 12/18; H04W 4/38

(52) U.S. Cl. CPC H04W 64/003; H04L 12/1818; H04W 4/38

(57) ABSTRACT

A method for tracking objects entering and exiting a work zone includes: accessing a first set of entry and exit events recorded by a first sensor block during a first time period; deriving a first uncorrected occupancy count for the work zone based on the first set of entry and exit events; accessing a baseline occupancy count; deriving an occupancy bias function for the work zone based on a difference between the first uncorrected occupancy count and the baseline occupancy count; accessing a second set of entry and exit events recorded by the first sensor block, during a second time period; deriving a second uncorrected occupancy count for the work zone based on the second set of entry and exit events; and correcting the second uncorrected occupancy count according to the occupancy bias function to calculate a second corrected occupancy count for the work zone.

### CROSS-REFERENCE TO RELATED APPLICATIONS

This Application claims the benefit of U.S. Provisional Application No. 63/567,682, filed on 20 Mar. 2024, which is incorporated in its entirety by this reference.

### TECHNICAL FIELD

This invention relates generally to the field of workplace monitoring and, more specifically, to a new and useful method for tracking and recalibrating quantities of objects in the field of workplace monitoring.

### BRIEF DESCRIPTION OF THE FIGURES

FIGS. 1A and 1B are flowchart representations of a method;

FIG. 2 is a flowchart representation of one variation of the method;

FIG. 3 is a flowchart representation of one variation of the method;

FIG. 4 is a flowchart representation of one variation of the method; and

FIGS. 5A, 5B, and 5C are flowchart representations of one variation of method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

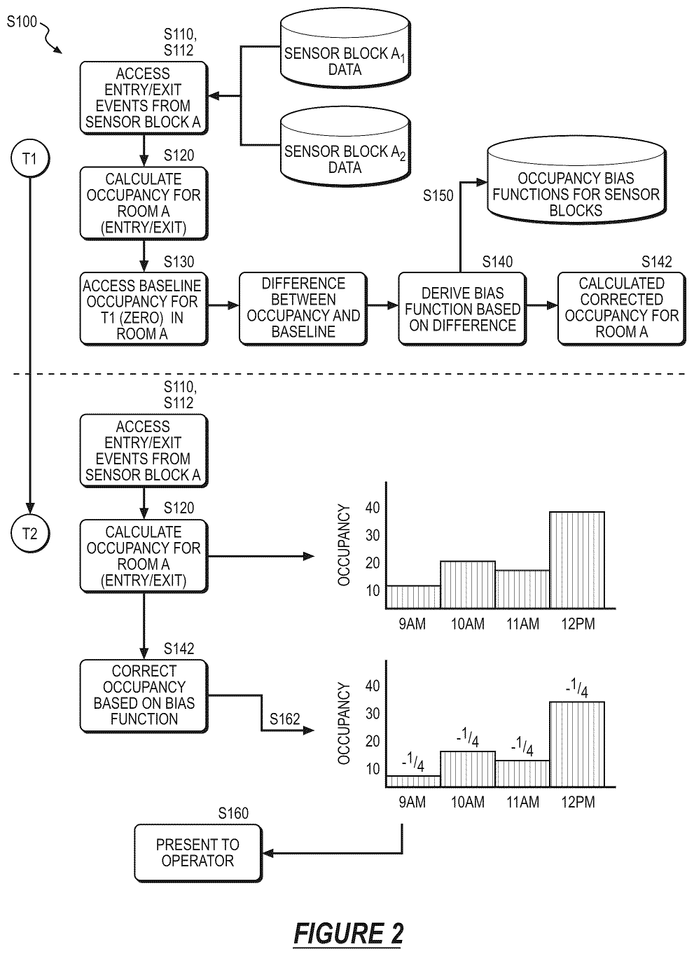

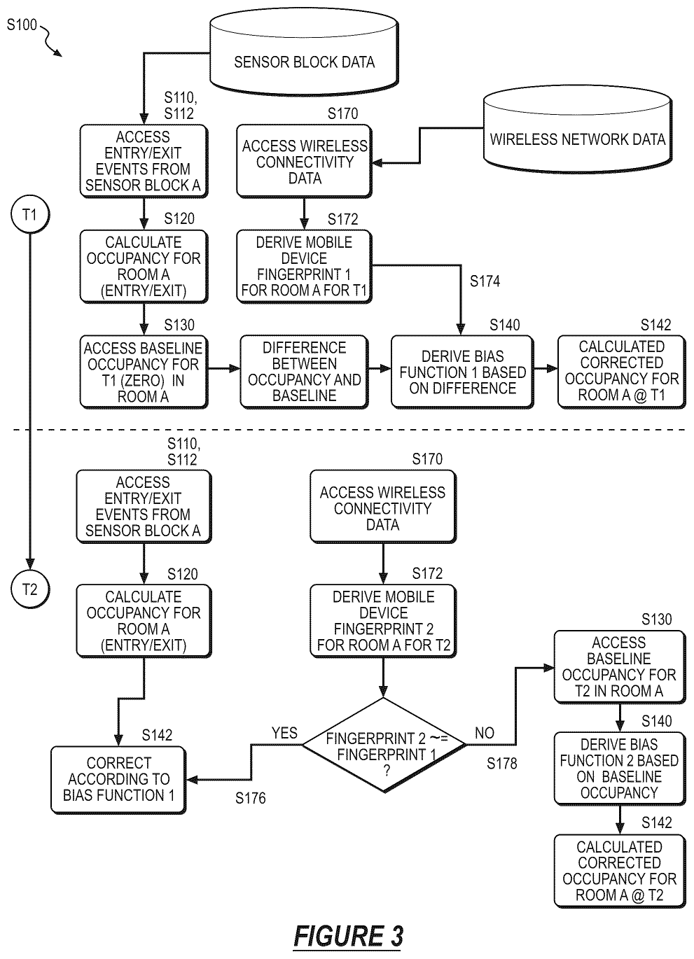

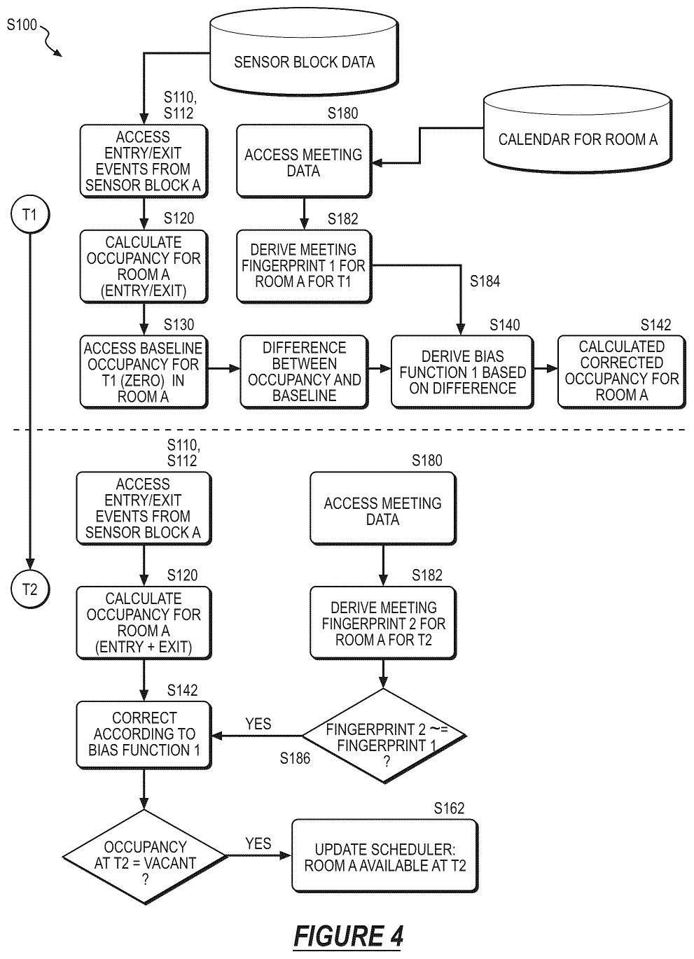

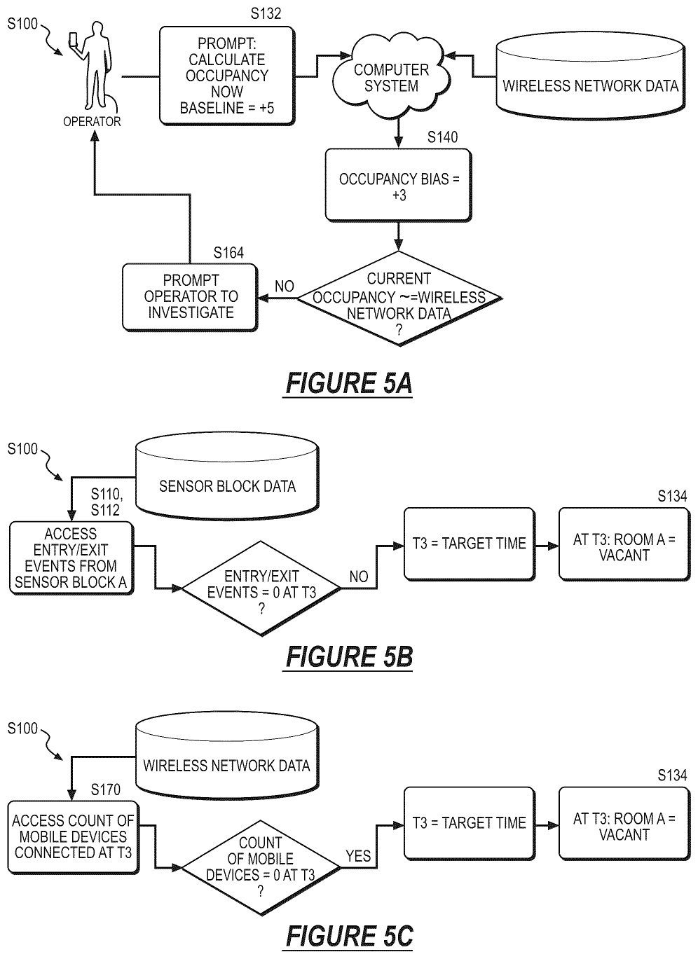

As shown in FIG. 2, a method S100 includes, for a first time period: accessing a first set of entry events recorded by a first sensor block, deployed within the work zone, during the first time period in Block S110; accessing a first set of exit events recorded by the first sensor block during the first time period in Block S112; deriving a first uncorrected occupancy count for the work zone at a first target time, during the first time period, based on the first set of entry events and the first set of exit events in Block S120; accessing a baseline occupancy count for the first target time in Block S130; and deriving a first occupancy bias function for the work zone based on a difference between the first uncorrected occupancy count and the baseline occupancy count in Block S140.

The method further includes, for a second time period: accessing a second set of entry events recorded by the first sensor block, deployed within the work zone, during the second time period in Block S110; accessing a second set of exit events recorded by the first sensor block during the second time period in Block S112; deriving a second uncorrected occupancy count for the work zone at a second target time, during the second time period, based on the second set of entry events and the second set of exit events in Block S120; correcting the second uncorrected occupancy count according to the first occupancy bias function to calculate a second corrected occupancy count for the work zone at the second target time in Block S142; and, proximal the second target time, updating a representation of the work zone, in a visualization of the space rendered on a display, according to the second corrected occupancy count in Block S162.

### 1.1 Variation: Wireless Access Point Baselining

In one variation, the method S100 for tracking objects entering and exiting a work zone within a space includes, for a first time period: accessing a first set of entry events recorded by a first sensor block, deployed within the work zone, during a first time period in Block S110; accessing a first set of exit events recorded by the first sensor block during the first time period in Block S112; deriving a first uncorrected occupancy count for the work zone at a first target time, during the first time period, based on the first set of entry events and the first set of exit events in Block S120; accessing a first set of wireless connectivity data representing a first set of mobile devices connected to a first wireless access point, deployed within the space, during the first time period in Block S170; and, in response to the first set of wireless connectivity data indicating a target occupancy at a first target time, accessing a baseline occupancy count for the first target time in Block S130 and deriving a first occupancy bias function for the work zone based on the first uncorrected occupancy count and the baseline occupancy count in Block S140.

This variation of the method further includes, for a second time period: accessing a second set of entry events recorded by the first sensor block, deployed within the work zone, during the second time period in Block S110; accessing a second set of exit events recorded by the first sensor block during the second time period in Block S112; deriving a second uncorrected occupancy count for the work zone at a second target time, during the second time period, based on the second set of entry events and the second set of exit events in Block S120; correcting the second uncorrected occupancy count according to the first occupancy bias function to calculate a second corrected occupancy count for the work zone at the second target time in Block S142; and, proximal the second target time, updating a representation of the work zone, in a visualization of the space rendered on a display, according to the second corrected occupancy count in Block S162.

### 1.2 Variation: Real-time Correction

In another variation, the method S100 for tracking objects entering and exiting a work zone within a space includes: accessing a first set of entry events recorded by a first sensor block, deployed within the work zone, during a first time period in Block S110; accessing a first set of exit events recorded by the first sensor block during the first time period in Block S112; deriving a first uncorrected occupancy count for the work zone at a first target time, during the first time period, based on the first set of entry events and the first set of exit events in Block S120; accessing a first set of wireless connectivity data representing a first set of mobile devices connected to a first wireless access point, deployed within the space, during the first time period in Block S170; in response to the first set of wireless connectivity data indicating a target occupancy count at a first target time, deriving a first occupancy bias function for the work zone based on a difference between the first uncorrected occupancy count and the target occupancy count in Block S140; correcting the first uncorrected occupancy count according to the first occupancy bias function to calculate a first corrected occupancy count for the work zone at the first target time in Block S142; and, proximal the first target time, updating a representation of the work zone, in a visualization of the space rendered on a display, according to the first corrected occupancy count in Block S162.

### 1.3 Variation: Timestamps

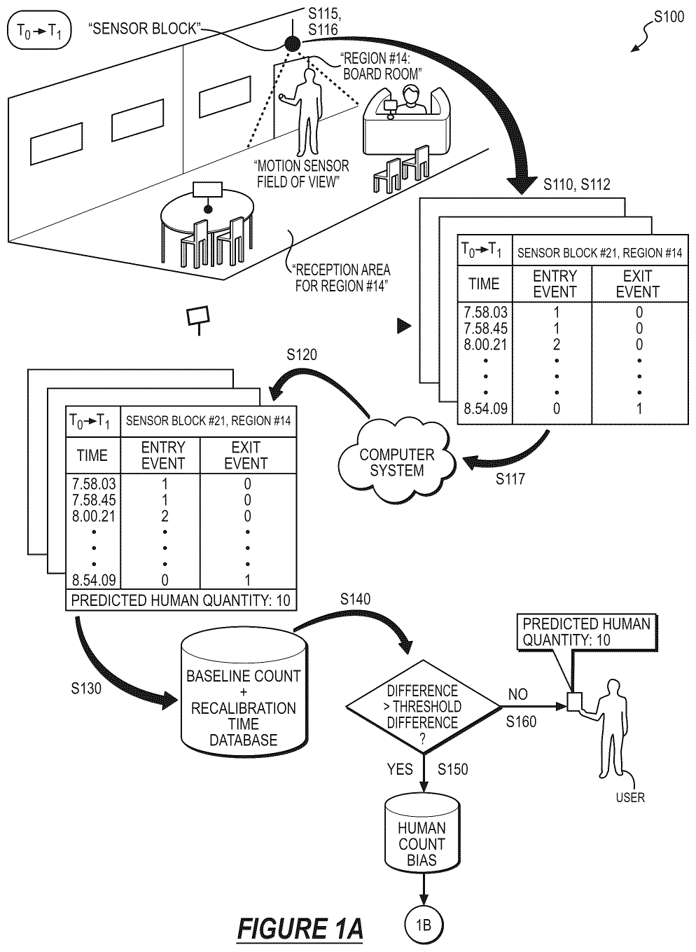

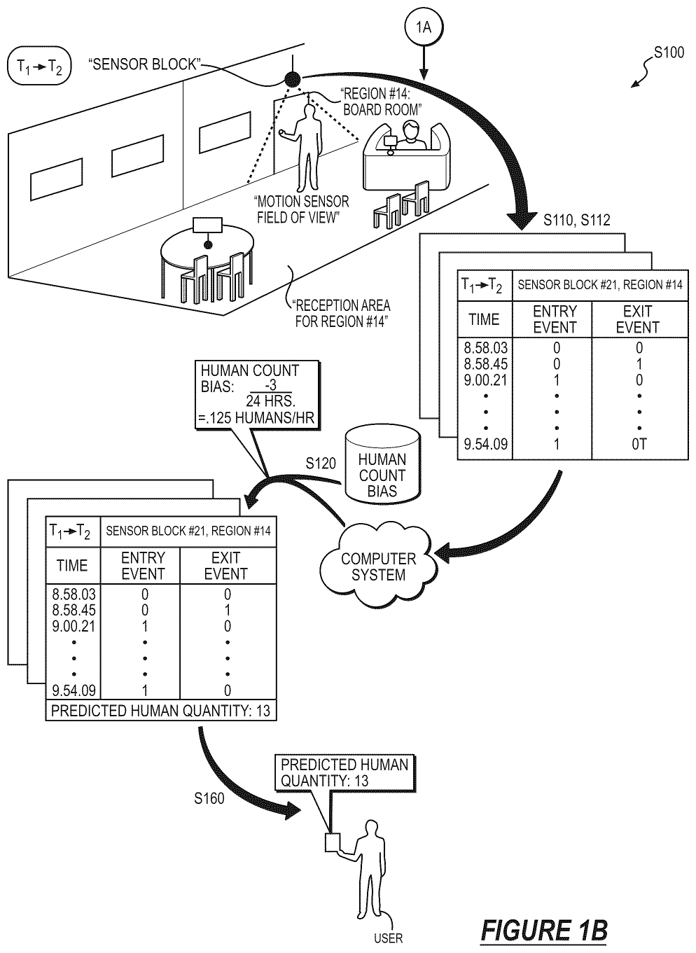

As shown in FIGS. 1A and 1B, yet another variation of the method S100 for tracking objects entering and exiting a space includes, during a first time interval: accessing a first set of entry events, annotated with timestamps and representing movement of humans into a region of the space, from a first sensor block associated with the region in Block S110; accessing a first set of exit events, annotated with timestamps and representing movement of humans from the region of the space, from the first sensor block in Block S112; deriving a first human count representing a first predicted quantity of humans occupying the region based on the first set of entry events and the first set of exit events in Block S120; retrieving a baseline time intersecting the first time interval and associated with a baseline human count representing a baseline quantity of humans occupying the region in Block S130; calculating a difference between the first human count and the baseline human count for the region in Block S140; and storing a human count bias for the region based on the difference in Block S150.

This variation of the method S100 further includes, during a second time interval: accessing a second set of entry events, annotated with timestamps and representing movement of humans into the region, from the first sensor block in Block S110; accessing a second set of exit events, annotated with timestamps and representing movement of humans from the region of the space, from the sensor block in Block S112; and deriving a second human count representing a second predicted quantity of humans occupying the region based on the second set of entry events and the second set of exit events. The method S100 also includes: correcting the second human count proportional to the human count bias in Block S120; and presenting the second human count for the region to a user in Block S160.

### 2. Applications

Generally, Blocks of the method S100 can be executed by each sensor block, in a population of sensor blocks, associated with (i.e., deployed in) a work zone of an office space (e.g., a board room, a conference room, an agile work environment, a reception area, a lounge, or a hallway): to detect motion of objects within a field of view of a sensor block (e.g., motion sensor, threshold sensor, optical sensor); to interpret motion as a human entering into and exiting from a doorway of the work zone; and to record a timestamp for each entry and exit event of a human entering into and exiting from the work zone over a time interval (e.g., twenty-four hours).

Furthermore, a computer system can cooperate with the population of sensor blocks to execute Blocks of the method S100: to access entry/exit events from each sensor block in the population of sensor blocks during the time interval; to derive a human count for each region in the space (i.e., a predicted quantity of humans occupying each work zone) based on these entry/exit events; to detect a difference, such as a human count bias (e.g., a positive difference value +7 or a negative difference value −3), between the human count and a baseline human count (e.g., a null quantity of humans) associated with a baseline time of day when the space exhibits a default state; and to selectively increment or decrement the human count for each region in the space proportional to the human count bias in real-time—such as for each hour within the time interval. Alternatively, the computer system can transmit the human count bias for each region to a corresponding sensor block in the population of sensor blocks and the sensor block can selectively increment or decrement the human count for each region in the space proportional to the human count bias in real-time.

In particular, the computer system can derive a bias function and correct human occupancy counts from threshold sensors (e.g., count individual humans and correct for duplicate and missed count rates): based on expected zero-human-occupancy periods for high accuracy and moderate latency calculation; and/or based on device occupancy data captured by wireless access points for low latency and responsive calculation, such as in response to detecting movement of mobile devices indicating presence of humans and an unknown (or variable) ratio of mobile devices to humans.

### 2.1 Single-sensor Bias Function Derivation

Generally, the computer system can: access a set of entry/exit events, such as from a particular sensor block deployed within a space, representing humans entering and exiting the space during a baseline time period; calculate an estimated occupancy of the space based on the set of entry/exit events; and calculate a sensor block bias function based on a difference between a known occupancy and the estimated occupancy of the space. The computer system can then: correct the occupancy of the work zone for the baseline time period based on the sensor block bias; and apply the sensor block bias function to future occupancy counts for the work zone to dynamically correct the occupancy count for the space in (near) real time.

In particular, the computer system can characterize a bias (e.g., drift, missed human-threshold counts, duplicate human-threshold counts) for the sensor block, such as based on ambient characteristics (e.g., wireless access data, lighting changes throughout a time period, temperature) and/or a known occupancy, such as a vacant state of the space at a target time. The computer system can then correct: an occupancy count for the space associated with the sensor block during a subsequent period based on the bias; and update a representation of the space, such as a visualization of a scheduler, to reflect this corrected occupancy count for the space.

Additionally, the computer system can implement regression, machine learning, and/or other computer vision techniques to develop correction prediction models to generate a correction frequency (e.g., once per hour, one per ten-minute interval) to return the human count to a baseline count, such as a null quantity of humans, in each region (e.g., return the human count to a baseline count once per hour or once per ten-minute interval) of the space. In particular, the computer system can: track absence of humans within the space over a period of time (e.g., one day, one week, one month); access occupancy data, defined by the user, for each region in the space; and derive correction prediction models linking the occupancy data and human absence patterns to generate a correction frequency for each region to return the human count to the baseline count. The computer system (or the population of sensor blocks) can then implement the correction frequency to return the human count to the baseline count.

The computer system can implement the methods and techniques as described herein for each sensor block in a population of sensor blocks deployed in the space to: calculate a bias function during a baseline time period; correct an occupancy count for a target time period; and dynamically update the occupancy count for the space, such as in a representation presented to an operator.

### 2.2 Bias Function Selection+Work Zone Characteristics

In one variation, the computer system can implement methods and techniques described herein across a series of time periods: to calculate a set of bias functions for the work zone; to associate these bias functions with different conditions within the work zone; and to selectively apply these bias functions based on current work zone conditions in order to achieve accurate occupancy counts within the work zone over a range of work zone conditions.

For example, for a particular sensor block, the computer system can track occupancy of the space, based on data recorded by the sensor block, and derive occupancy bias functions over a set of time periods; and associate characteristics of the work zone with the occupancy bias function (e.g., a connectivity fingerprint, a meeting fingerprint). Then, at a second time and in response to detecting similar characteristics for a second time period (e.g., prior to occupancy calculation) to a previous time period, the computer system can select the bias function associated with (e.g., calculated for) the first time period to correct a second occupancy count for the second time period.

In this variation, the computer system can: select a bias function, from a set of bias functions, associated with dynamic characteristics of a particular time period, such as wireless connectivity data, meeting data, energy consumption data, noise (e.g., from a sound sensor, microphone, building management system), ambient temperature (e.g., an increase in temperature indicating increase in occupancy) based on prior occupancy data and dynamic occupancy characteristics approximating a current state (or near-current, such as within a time period of interest); and select and apply a particular bias function based on correspondence between these characteristics.

In one variation of the method, the computer system can: access wireless connectivity data, representing devices connected to a wireless network deployed within the space; estimate a target time characterized by a target occupancy (e.g., vacant, zero-occupancy); and associate the target time with a baseline time at which to calculate the uncorrected occupancy and a difference between the uncorrected occupancy and baseline (e.g., known) occupancy. In one example, the computer system: accesses wireless connectivity data of devices connected to a wireless network deployed within the space; detects absence of mobile devices connected to the wireless network and presence of assets associated with the space connected to the wireless network; and detects a vacant state (e.g., zero-occupancy count) of the space based on the absence of mobile devices connected to the wireless network at a particular time.

At the particular time, the computer system can calculate a difference between an occupancy estimation (e.g., a positive difference value +7 or a negative difference value-3) to derive an occupancy bias function for the sensor block and/or the work zone. Additionally, the computer system can: construct a connectivity fingerprint based on the wireless connectivity data representing mobile devices connected to the wireless network, distribution of devices, device density, device locations/heatmap of devices; and associate the connectivity fingerprint with the occupancy bias function.

Then, at a second time, the computer system can: detect a similar connectivity fingerprint to the first time period; and apply the first occupancy bias function to the second time period based on correspondence between the two fingerprints indicating similar occupancy and/or density of occupancy of the work zone during a similar time interval.

In a similar implementation, the computer system can: access a calendar associated with the work zone defining meeting data such as expected occupancy throughout a time period; generate a meeting fingerprint based on the calendar; and associate the meeting fingerprint with the occupancy bias function derived for that time period.

The computer system can then implement methods and techniques described herein for a series of time periods to calculate meeting fingerprints. In response to a current meeting fingerprint approximating a previously calculated meeting fingerprint, the computer system can select the occupancy bias function associated with the old meeting fingerprint and apply the selected occupancy bias function to the current time period.

Therefore, by identifying associations between characteristics of the work zone throughout particular time periods and selecting and implementing relevant occupancy bias functions, the computer system increases efficiency by eliminating calculation of uncorrected occupancy to thus enable the computer system to update occupancy (e.g., via an occupancy graph, a representation of the space) in (near) real-time.

The method S100 is described herein as executed by a computer system (e.g., remote server) in conjunction with a population of sensor blocks to track real-time movement of objects, to record entry/exit events of objects in and out of each region within an office space, and to predict a quantity of humans occupying each region. However, Blocks of the method S100 can additionally or alternatively be executed by the population of sensor blocks, by a local computer system, by a network of wireless sensors, by a network of sensor blocks, etc. to track real-time movement of objects, to record entry/exit events of humans, and to predict a quantity of humans occupying each region in an industrial space, an educational space, a clinical space, or a space of any other type.

### 3. Sensor Block

A sensor block can include: a motion sensor configured to detect motion in or near the field of view of the optical sensor; a processor configured to interpret data from movement recorded by the motion sensor; a wireless communication module configured to wirelessly transmit these data; a battery or wired power supply configured to power the motion sensor, the processor, and the wireless communication module over an extended duration of time (e.g., one year, five years); and an housing configured to contain the motion sensor, the processor, the wireless communication module, and the battery and configured to mount to a surface with the field of view of the motion sensor intersecting a doorway within the facility (e.g., a doorway to a board room, an entrance to a reception area).

The motion sensor can include a passive infrared sensor (or “PIR” sensor) that defines a field of view that overlaps the field of view of the optical sensor and that passively outputs a signal representing movement of objects within (or near) the field of view of the motion sensor. The sensor block can: transition from an inactive state to an active state responsive to an output from the motion sensor indicating motion in the field of view of the motion sensor; trigger the motion sensor to record movement of an object; and interpret the movement as an entry/exit event into the region within the space.

In one variation, the sensor block includes an optical sensor defining a field of view. The optical sensor can include: a color camera configured to record and output 2D color images; and/or a depth camera configured to record and output 2D depth images or 3D point clouds. However, the optical sensor can define any other type of optical sensor and can output visual or optical data in any other format.

In one example, the motion sensor is coupled to a wake interrupt pin on the processor. However, the motion sensor can define any other type of motion sensor and can be coupled to the processor in any other way to trigger the sensor block to enter an image-capture mode, responsive to motion in the field of view of the motion sensor.

In another variation, the sensor block also includes: a distance sensor (e.g., a 1D infrared depth sensor); an ambient light sensor; a temperature sensor; an air quality or air pollution sensor; and/or a humidity sensor. However, the sensor block can include any other ambient sensor. In the active state, the sensor block can sample and record data from these sensors and can selectively transmit these data—paired with insights extracted from images recorded by the sensor block—to a local gateway. The sensor block can also include a solar cell or other energy harvester configured to recharge the battery.

The processor can locally execute Blocks of the method S100, to selectively wake responsive to an output of the motion sensor, to trigger the optical sensor to record an image, to write various insights extracted from the image, and to then queue the wireless communication module to broadcast these insights to a nearby gateway for distribution to the computer system when these insights exhibit certain target conditions or represent certain changes.

The optical sensor, motion sensor, battery, processor, and wireless communication module, etc. can be arranged within a single housing configured to install on a flat surface-such as by adhering or mechanically fastening to a wall or ceiling-with the field of view of the optical sensor facing outwardly from the flat surface and intersecting an region of interest within the space.

However, this “standalone,” “mobile” sensor block can define any other form and can mount to a surface in any other way.

### 3.1 Wired Power & Communications

In one variation, the sensor block additionally or alternatively includes a receptacle or plug configured to connect to an external power supply within the facility—such as a power-over-Ethernet cable-and sources power for the optical sensor, processor, etc. from this external power supply. In this variation, the sensor block can additionally or alternatively transmit data-extracted from images recorded by the sensor block-to the computer system via this wired connection (i.e., rather than wirelessly transmitting these data to a local gateway).

### 3.2 Data Sampling Frequency

Generally, once deployed in a space, a sensor block can track: entry events of objects (e.g., humans) entering the space in Block S115 of the method; and exit events of objects (e.g., humans) exiting the space in Block S116 of the method. In particular, the sensor block can: capture images depicting a nearby region of the space; extract non-optical data from these images; extract characteristics of constellations of objects detected in these images; compile and annotate these data; and transmit these data to the computer system in Block S117 of the method.

In one implementation, the sensor block can define a sampling frequency (i.e., adjust the image rate of the optical sensor) based on conditions within its field of view, such as: once per ten-minute interval when the sensor block detects absence of motion in its field of view; once per one-minute interval when the sensor block detects motion in a human counter region within the field of view of the sensor block; or once per one-second interval when the sensor block detects motion in the human counter region within the field of view of the sensor block. During each sampling period, the sensor block can: capture an image; extract features in the image; detect and classify types of objects (e.g., humans, human effects, office furniture, other assets) in the field of view of the sensor block based on these features; extract locations, orientations, and positions of these objects in the field of view of the sensor block based on positions of corresponding features in the image; and/or detect entry/exit events of humans detected in this image based on their relative positions and orientations. The sensor block can also: annotate the quantity and locations of these humans and other objects with a timestamp of the image and a unique identifier (e.g., a UUID, MAC address, IP address, or other wireless address, etc.) of the sensor block; and transmit these data to the computer system, such as via a wired or wireless connection (e.g., via the local gateway).

The sensor block can additionally or alternatively: repeat these processes over multiple consecutive sampling periods; track movement of objects detected in consecutive images captured over short time intervals; detect entry/exit events of these objects (e.g., humans) over corresponding time intervals based on their relative positions detected in these images; and transmit these entry/exit events to the computer system.

### 4. Local Gateway

The system can also include a local gateway: configured to receive data transmitted from sensor blocks nearby via wireless communication protocol or via a local ad hoc wireless network; and to pass these non-optical data to the computer system, such as over a computer network or long-range wireless communication protocol. For example, the gateway can be installed near and connected to a wall power outlet and can pass data received from a nearby sensor block to the computer system in (near) real-time. Further, multiple gateways can be installed throughout the facility and can interface with many sensor blocks installed nearby to collect data (e.g., entry/exit events) from these sensor blocks and to return these data to the computer system.

In one variation, the sensor block transmits a (raw or compressed) image-recorded by the optical sensor in the sensor block during a scan cycle executed by the sensor block while in an active state-to a nearby gateway, and the gateway executes the method and techniques described above and below to extract insights from this image and to return these insights to the computer system (e.g., scans the raw or compressed image).

### 5. Computer System

The computer system (e.g., a remote server) can receive non-optical data—such as entry/exit events of humans interpreted from motion detected by the motion sensor in the sensor block during a particular human counter time interval and executed by the sensor block in an active state-directly from each sensor block in the population of sensor blocks and can further manipulate these non-optical data to generate real-time outputs of a human count, such as a predicted quantity of humans occupying regions within the space.

In one variation, the computer system can receive entry/exit events of humans extracted from a (raw or compressed) image recorded by the optical sensor in the sensor block during the particular human counter time interval and executed by the sensor block while in an active state-from one or more gateways installed in the facility (or directly from sensor blocks) and can further manipulate these non-optical data to generate long-term occupancy insights of object movement throughout regions within the space and/or real-time outputs of a human count, such as a predicted quantity of humans, occupying each region, as further described below.

### 6. Installation+Initialization

Generally, an installer or an administrator of the space can install each sensor block proximal (e.g., outside of, within a threshold distance of) a region in the space such that the field of view of the motion sensor, arranged in each sensor block, intersects a doorway to the region (e.g., a board room, a conference room, a lobby).

In one implementation, a sensor block can be installed proximal a threshold of a work zone and/or a space, such as proximal a doorway, to enable the sensor block to detect entry/exit events through the doorway. For example, in this implementation, a first sensor block can be deployed proximal a conference room threshold of a conference room.

In another implementation, a first sensor block and a second sensor block can be deployed proximal a threshold of a work zone. In this implementation, the first sensor block and the second sensor block can: record the first set of entry events; record the first set of exit events; and transmit the first set of entry events and the first set of exit events to the remote computer system. Accordingly, in this implementation, the computer system can access the first set of entry events and the second set of exit events recorded by the first sensor block and the second sensor block.

Therefore, in this implementation, if a first sensor block in the population of sensor block defines a bias (or “drift”), a second sensor block can be deployed proximal the first sensor block to record entry/exit events at the same location to “offset” the bias of the first sensor block.

In yet another implementation, the administrator may define regions in a map of the space, annotate each region with a boundary, and label the region with a maximum occupancy capacity. Further, the administrator may assign a time interval for human counting or entry/exit event detection to particular regions in the map of the space. The administrator may also define a baseline time associated with a baseline human count or a default state-such as a null quantity of humans or a zero state of humans-for each region of the space via the user portal.

In one example, the administrator: defines a region representing a board room in a floorplan of an office space; defines a boundary for human counting proximal (e.g., within a threshold distance of) a doorway to the board room in the floorplan; labels the board room with a maximum occupancy capacity of 20 humans; assigns a time interval for human counting, such as during work hours between 7 AM and 5 PM, to the board room in the floorplan of the office space; and defines a baseline time of day, such as 12 AM, when the board room exhibits human absence or a baseline quantity of humans, such as zero humans, for an extended period of time (e.g., one hour, two hours).

In another example, the administrator: defines a region representing a conference room in a floorplan of a workplace; defines a boundary for entry/exit event detection proximal (e.g., nearby, within a threshold distance of) a doorway to the conference room in the floorplan; labels the conference room with a maximum occupancy capacity of 50 humans; assigns a time interval for entry/exit event detection, such as between 7AM and 11AM, to the conference room in the floorplan of the workplace; and defines a baseline time when the conference room exhibits a default state (e.g., a null quantity of humans or a zero state of humans), such as 6 PM succeeding a cleaning or maintenance period for the conference room.

Additionally, upon installation of a sensor block proximal (e.g., outside of, within a threshold distance of) a region of the space, the sensor block can detect motion of a human, such as an installer or administrator, entering into and exiting from a doorway (e.g., an entrance, an exit, a stairway, an elevator, an entryway, a gate) to the region of the space via the motion sensor arranged in the sensor block and interpret motion of the human as entry/exit events. Further, the sensor block can offload these entry/exit events to the computer system and the installer or administrator can review these entry/exit events to confirm the doorway intersects the field of view of the motion sensor. Further, the sensor block can detect absence of motion via the motion sensor at a time corresponding to a baseline time associated with a default state for the region, such as 11 PM or upon cleaning or maintenance performed within the region, to confirm absence of humans at the baseline time.

Therefore, each sensor block, in the population of sensor blocks deployed in the space, can access locational context, time intervals, maximum occupancy data, lighting conditions of regions in the space to inform human counting calculations, predicted quantities of humans, and entry/exit event detections, as further described below.

### 7. Entry/Exit Event Detection

Generally, each sensor block can track movement of objects, such as movement of humans in and out of an entrance or exit within a region of the space, during a time period assigned to this region via the motion sensor. In particular, each sensor block can record entry/exit events for the particular region occurring during the time period and transmit these entry/exit data to the computer system. The computer system can then derive a timeseries of entry/exit events and thus, calculate a total human count for the region (e.g., a predicted quantity of humans occupying the region during the time period).

Additionally or alternatively, each sensor block can derive a timeseries of entry/exit events and calculate a total human count for this region rather than transmitting the entry/exit events to the computer system for calculation of the total human count for the region.

### 7.1 Motion-Based Object Detection

In one implementation, the sensor block can define a motion sensor: deployed proximal a threshold of the region; and configured to track motion about the threshold (e.g., entry events, exit events). In this implementation, the motion sensor can: detect a first motion in a first direction as an entry event; and detect a second motion in a second direction, opposite the first direction, as an exit event.

In particular, the sensor block can: detect motion-within the field of view of the motion sensor arranged in the sensor block-representing movement of a human entering into or exiting from a doorway of a region in the space during a time interval assigned to this region; interpret movement of a human entering into the doorway of the region as an entry event; interpret movement of a human exiting from the doorway of the region as an exit event; record each occurrence of an entry event and exit event with a corresponding timestamp; and offload these entry and exit events to the computer system for generation of a human count representing a predicted quantity of humans occupying the region.

For example, in this implementation, a first sensor block including a motion sensor deployed proximal a threshold of the work zone can: record the first set of entry events during the first time period; record the first set of exit events during the first time period; and transmit the first set of entry events and the first set of exit events to a remote computer system.

In one variation, the sensor block can include an ultrasonic sensor. In this variation, the sensor block can: emit a transmit sound wave (e.g., a high-frequency sound wave) within a threshold distance of the doorway of the region via the ultrasonic sensor; detect a receive sound wave corresponding to the transmit sound wave via the ultrasonic sensor; and transform the transmit sound wave and the receive sound wave into an entry event representing movement of a human into the region or an exit event representing movement of a human from the region.

In another variation, the sensor block can include a microwave sensor. In this variation, the sensor block can: transmit a pulse within a threshold distance of the doorway of the region via the microwave sensor and detect a reflection of the pulse from an object (or a set of objects) moving within the field of view of the microwave sensor. Further, the sensor block can: detect a direction of the reflection representing movement of the object; and, in response to the direction facing the field of view of the microwave sensor, interpret movement of the object as an exit event for the region. Alternatively, in response to the direction facing away from the field of view of the microwave sensor, the sensor block can interpret movement of the object as an entry event for the region.

The sensor block can repeat these methods and techniques for each other object or set of objects moving within the field of view of the microwave sensor, for each other human counter time interval, and for each other region in the space to generate a report (e.g., a list, a table) of entry/exit events of objects for the space and offload this report to the computer system to derive a total human count for each region in the space, such as a predicted total quantity of humans occupying each region in the space.

### 7.2 Optical Sensor+Motion Sensor Object Tracking

In one variation, upon installation of a sensor block within a threshold distance of a region of the space, the sensor block can: capture an initialization image, via the optical sensor, depicting the region in order to identify an entrance and/or an exit (e.g., a doorway, a stairway, an elevator, an entryway, a gate) in the region and/or to label various areas of the region (defined by pixel regions within the field of view of the optical sensor) with locational context in the map of the space. Further, the sensor block can capture an initialization image at the optical sensor at a time corresponding to a known vacant or default state of the region, such as 11 PM or upon cleaning or maintenance performed within the region. In one implementation, the sensor block can record multiple initialization images via the optical sensor in multiple lighting conditions (e.g., bright, daylight, dark) to improve entry/exit detection and object detection across these lighting conditions. The computer system can then transmit the locational context, time intervals, and maximum occupancy data to corresponding sensor blocks deployed throughout the space.

Thus, each sensor block, in the population of sensor blocks deployed in the space, can further access lighting conditions in addition to locational context, time intervals, and maximum occupancy data of regions in the space to inform object detection, human counting calculations, and entry/exit event detections.

In one implementation, the sensor block can: access a sequence of images representing a particular region within the space and captured by the optical sensor arranged in the sensor block; identify a constellation of objects within each image in the sequence of images; and execute an object classification model trained to classify object types—such as human object types, chair object types, desk object types, or table object types—within each image. Then, responsive to identifying a constellation of objects in the sequence of images, the sensor block can: classify an object type of a first object, such as a human object type, in the constellation of objects; identify a location and an orientation of the first object in the particular region; and, based on the orientation of the first object, record an entry/exit event representing movement of the first object in or out of the particular region.

### 7.2.1 Image-Based Tracking of Objects

In one variation, the sensor block can: detect presence of motion within the field of view of the motion sensor arranged in the sensor block and, in response to detecting presence of motion, capture a first image depicting a region in the space, via the optical sensor, during a time interval assigned to the region. Then, the sensor block can: extract a set of features from the image; detect a constellation of objects including a human based on the set of features; extract a location and an orientation of the human from the image; and record an entry event of the human according to the orientation and the corresponding timestamp in a list associated with the region.

For example, at a first time, the sensor block can: detect presence of motion within the field of view—intersecting a doorway of a conference room—of the motion sensor arranged in the sensor block; and, in response to detecting presence of motion, capture a sequence of images depicting the conference room via the optical sensor. The sensor block can then: extract a first set of features from a first image in the sequence of images; detect a constellation of objects including a first human based on the first set of features; extract a first location and a first orientation of the first human from the first image; and, in response to the first orientation of the first human facing away from the doorway of the conference room, record a first entry event representing the first human entering the doorway of the conference room and a first timestamp of the first image.

At a second time, the sensor block can: extract a second set of features from a second image in the sequence of images; detect a constellation of objects including a second human based on the second set of features; extract a second location and a second orientation of the second human from the second image; and, in response to the second orientation of the second human facing toward the doorway of the conference room, record a first exit event representing the second human exiting the conference room through the doorway and a second timestamp of the second image. The sensor block can then offload the first entry event and the first exit event to the computer system and the computer system can derive a human count for the conference room.

The sensor block can repeat these methods and techniques for each other image in the sequence of images, for each other human counter time interval, and for each other region in the space to generate a report (e.g., a list, a table) of entry/exit events of humans for the space and offload this report to the computer system to derive a total human count for each region in the space.

In another variation, the sensor block can identify a target of a human's attention in the region. For example, based on a pose of a human identified in multiple consecutive images, the sensor block can: detect the direction in which the human is looking; identify a doorway within a threshold viewing angle of this direction as the human's intent to exit this region through the doorway; and record an exit event representing movement of this human out of the region. Alternatively, the sensor block can identify a doorway opposite to the direction and within a threshold distance of the doorway, such as within one foot of the doorway, as the human entering the region through the doorway and record an entry event representing movement of the human into the region.

Additionally, the computer system can access the sequence of images from the sensor block and implement the methods and techniques described above to record entry/exit events of humans for the region and calculate a total human count of the region based on these entry/exit events.

Therefore, the sensor block can: track movement of objects, such as humans entering and exiting a region of the space over a period of time; record entry/exit events of these humans for the region and a timestamp according to the orientation of each human to collect a timeseries of entry/exit events; and offload the timeseries of entry/exit events to the computer system to derive occupancy metrics and insights of the region.

### 7.2.2 Image Capture+Temporary Storage

In one implementation, a sensor block can capture an image or a sequence of images at the optical sensor arranged in the sensor block depicting an entrance and/or exit in a region of the space, responsive to presence of motion in the field of view of the motion sensor arranged in the sensor block.

In one variation, the sensor block can capture images at a frequency greater than one hertz in order to detect a head of a human moving through the entrance and/or exit in the region. Further, the sensor block can: capture a sequence of low-resolution images; temporarily and locally store these images until the sensor block detects a location and an orientation of a head of a human based on a single image and/or the sequence of low-resolution images, at which time the sensor block can delete the single image and/or the sequence of low-resolution images from temporary storage.

Therefore, the sensor block can address privacy concerns related to the deployment of sensor blocks within the facility and reduce the possibility of accessing or recovering images depicting characteristics of humans by deleting images from temporary storage.

### 8. Occupancy Bias Detection

Generally, the computer system can detect biases (or “drifts”) for a sensor block and derive occupancy bias functions defining corrections for these biases in Block S142 of the method. In particular, the computer system can, for a particular time period: derive an uncorrected occupancy count (e.g., −5 humans, +7 humans); calculate a difference between a known occupancy count (e.g., +2 humans, zero humans) and the uncorrected occupancy count; and derive an occupancy bias function, representing a bias of the sensor block, based on the difference between the known occupancy count (e.g., +2 humans, zero humans) and the uncorrected occupancy count

In one implementation, the computer system can receive the entry/exit events from each sensor block deployed in the space and calculate a total human count for each region in the space. The computer system can then track the total human count for each region over a period of time (e.g., one day, twenty-four hours) in order to detect differences (e.g., human count bias) between corresponding time intervals within this period of time.

### 8.1 Baselining

Generally, Block S130 of the method recites accessing a baseline occupancy count for a work zone at a target time associated with a known or predictable occupancy (or vacancy). In particular, the computer system can, at a target baseline time (e.g., 2 AM, 7 AM, 9 PM), access a known occupancy count for the work zone to calculate an occupancy bias function.

In one variation, the computer system can: access a baseline time of day associated with a baseline count for this region (e.g., a known null human count for the region or a known null quantity of humans within the region) defined by the administrator of the space; receive entry/exit events from a sensor block, in the population of sensor blocks, deployed in a region of the space for the baseline time of day; and calculate an initial predicted quantity of humans occupying this region. Then, in response to detecting the initial predicted quantity of humans analogous (e.g., matching, corresponding) to the baseline count, the computer system can: track the human count for this region over a period of time (e.g., one day, twenty-four hours) from the baseline time of day; and calculate a first predicted quantity of humans occupying this region at the next baseline time of day. The computer system can then: detect a difference, such as a human count bias, between the initial predicted quantity of humans and the first predicted quantity of humans and automatically increment or decrement the human count for a next time interval proportional to the human count bias for this region.

For example, the computer system can: receive a set of entry/exit events from a sensor block, in the population of sensor blocks, deployed in a conference room in an office space; access a baseline time of day, such as 2 AM, associated with a baseline count (e.g., a null quantity of humans) for the conference room and defined by the administrator of the office space; extract a subset of entry/exit events, in the set of entry/exit events, such as null exit/entry events at 2 AM on Monday; and calculate an initial predicted quantity of humans occupying the conference room, such as zero humans occupying the conference room at 2 AM on Monday, based on the subset of entry/exit events. Responsive to identifying the initial human count analogous to the baseline count, the computer system can: track the human count for the conference room over a period of time, such as twenty-four hours, from the baseline time of day; and calculate a first predicted quantity of humans occupying the conference room at the next baseline time of day, such as 10 humans occupying the conference room at 2 AM on Tuesday. The computer system can then: detect a human count bias, between the initial predicted quantity of humans and the first predicted quantity of human, such as a negative value of three humans or −3; and automatically correct the human count for a next time interval (e.g., 24 hours) proportional to the human count bias for the conference room, such as correcting the predicted quantity of humans by 0.125 for each hour in this time interval.

Therefore, the computer system can detect a human count bias unique to each region in the space and automatically tune the human count bias in real-time. Thus, by correcting the human count for each region, the computer system can improve the accuracy of human count data and enable a user to achieve and maintain awareness of the human count and human movement data within the space in real-time.

### 8.2 Target Time Selection and Occupancy Count

Generally, the computer system can execute Blocks of the method to calculate an uncorrected occupancy count at a target time, such as a target time associated with a known or predictable occupancy (e.g., office space is closed, 3 a.m.).

In particular, the computer system can identify the target time based on: a current time indicating a baseline time; a target time defined by an administrator; and/or manually prompted at a particular time by an operator. In response to detection of the target time, the computer system: calculates the uncorrected occupancy count based on entry/exit events; and accesses a known occupancy count, such as a baseline occupancy count, associated with the target time.

In one example, the target time defines a target time during a time period during which the space is closed, indicating a vacant status of the space. Then, at the target time, the computer system can calculate the occupancy (e.g., +5 humans) based on entry/exit events occurring during the time period (e.g., working hours during a previous day) associated with the target time.

In one variation, the computer system can: detect a null set of entry/exit events during a particular time period; and associate the particular time period with a vacant state of the work zone. In this variation, the computer system can additionally or alternatively associate the particular time period with a target time at which to calculate the occupancy bias function. In one example, the computer system can: derive the first uncorrected occupancy count for the work zone at the first target time including a vacant occupancy time; and access the baseline occupancy count including a zero-occupancy count. In another example, at a third time, the computer system can: detect absence of entry and exit events recorded by the first sensor block; in response to detection of absence of entry and exit events recorded by the first sensor block, detect a vacant state of the work zone at the third time in Block S134 of the method; and derive the first uncorrected occupancy count for the work zone at the third time.

In another variation, the computer system receives a prompt from an operator, at a particular time, to calculate an uncorrected occupancy count for the space and derive an occupancy bias function in Block S132 of the method. Then, in response to receiving the prompt, the computer system can: calculate occupancy (e.g., +5 humans) based on entry/exit events occurring during the time period; prompt the operator to manually count occupancy of the work zone; and associate the manual operator count with a baseline occupancy at the target time. In particular, in this example, the computer system can, at the first target time: prompt an operator to input a manual occupancy count for the work zone in Block S132 of the method; and access the manual occupancy count input by the operator.

In yet another variation, the computer system can: access a first set of wireless connectivity data representing a first set of mobile devices connected to a first wireless access point, deployed within the work zone, during the first time period; detect a first time, during the first time period, characterized by a count of (e.g., absence) mobile devices connected to the first wireless access point; and derive the first uncorrected occupancy count for the work zone at the first target time including the first time. In particular in this variation, the computer system can: access wireless connectivity data, representing device connections to a wireless network associated with the work zone; detect a target device density of mobile devices (e.g., absence of mobile devices) at a first time indicating a target occupancy (e.g., vacant); and associate this first time with the target time.

In one variation, a target occupancy can define a target occupancy range. In this variation, the computer system can implement methods and techniques described herein to: access a first set of wireless connectivity data representing a first set of mobile devices connected to a first wireless access point, deployed within the work zone, during the first time period; detect a first time, during the first time period, characterized by wireless connectivity data indicating a target occupancy within the target occupancy range; and derive the first uncorrected occupancy count for the work zone at the first target time including the first time.

Accordingly, the computer system calculates an uncorrected occupancy count at the target time associated with a known occupancy count.

### 9. Bias Function Derivation

Generally, the computer system can calculate an occupancy bias function for a particular sensor block deployed in a work zone based on: a set of entry events recorded during a first time period; a set of exit events recorded during the first time period; and a baseline (e.g., known) occupancy count at a target time.

In one variation, once the computer system detects a human count bias for a region in the space, the computer system can: derive an occupancy bias function based on the human count bias; and selectively increment or decrement the human count during a next time interval (e.g., 24 hours) for this region in real-time based on the occupancy bias function.

In the foregoing example, the computer system can further: receive a set of entry/exit events detected by a sensor block deployed in a conference room in an office space during a time interval, such as 20 entry events and 5 exit events between 9 AM and 5 PM on Wednesday; calculate an uncorrected occupancy count representing the predicted quantity of humans occupying the conference room during this time interval based on the set of entry/exit events, such as 15 humans occupying the conference room; and selectively increment the uncorrected occupancy count, such as 15 humans, according to the occupancy bias function (e.g., proportional to the human count bias), such as a −3 per-24-hours, to generate a corrected occupancy count for the conference room, such as 15.125 humans, during this time interval. Therefore, the computer system can increment the occupancy count for each other hour in the 24-hour time interval to generate a corrected occupancy count for the conference room, such as 20 humans, and display the total human count for the conference room within a user portal.

Alternatively, responsive to detecting a positive value of humans as the human count bias for a particular region, the computer system can decrement the human count according to the occupancy bias function (e.g., proportional to the human count bias). For example, the computer system can: receive a set of entry/exit events detected by a sensor block installed outside of a board room in an office space during a time interval, such as 40 entry events and 15 exit events between 12 PM and 1 PM on Wednesday; calculate an uncorrected occupancy count representing the predicted quantity of humans occupying the board room during this time interval based on the set of entry/exit events, such as 30 humans occupying the office space; and selectively decrement the human count (e.g., 35 humans) according to the occupancy bias function, such as a positive value of 7 humans or +7 per-24-hours, to generate a corrected occupancy count for the board room, such as 34.708 humans. Therefore, the computer system can decrement the human count for each other hour in the 24-hour time interval to generate a total human count for the board room, such as 28 humans, and display the total human count for the board room within the user portal.

The computer system can repeat these methods and techniques for each other work zone in the space and display the corrected occupancy count for each work zone within the user portal to enable the user to achieve and maintain awareness of human occupancy in the space.

In another variation, the computer system can transmit an occupancy bias function to a corresponding sensor block deployed in the space. The sensor block can then locally implement methods and techniques described above to calculate the uncorrected occupancy count for the region and selectively increment or decrement the human count for this region according to the occupancy bias function in real time to calculate corrected (e.g., accurate) occupancy counts.

Therefore, the computer system (in cooperation with the population of sensor blocks) can selectively increment or decrement the occupancy count according to the occupancy bias function associated with each work zone (e.g., sensor blocks deployed within the work zone) to increase the accuracy and efficiency of occupancy data of the space in real-time.

### 10 Wireless Network Fingerprinting

Generally, the computer system can associate an occupancy bias function for a particular time period with a distribution of mobile devices throughout the space during that time period.

In particular, the computer system can: access a set of wireless connectivity data (e.g., device identifiers, device locations, connection events, disconnection events, timestamps, device density) associated with a population of wireless network wireless access points (e.g., deployed within the space) representing a set of devices connected to the wireless network during the time period in Block S170 of the method; construct a fingerprint (e.g., heatmap, density map, device identifiers, connection and/or disconnection events over the time period) of these devices based on distribution of devices in the set of devices throughout the space in Block S172 of the method; and associate the fingerprint with an occupancy bias function associated with the particular time period in Block S174 of the method.

### 10.1 Wireless Connectivity Data Filtering

In one implementation, the computer system can: access the set of wireless connectivity data; and filter the set of wireless connectivity data based on identifiers of known (e.g., fixed) devices prior to construction of the connectivity fingerprint.

In one example, the computer system can: access a set of wireless connectivity data; access a set of identifiers associated with fixed devices (e.g., printers, servers, conference phones, access control systems) within the space; and exclude the set of identifiers from the set of wireless connectivity data. In response to excluding fixed devices from the set of wireless connectivity data, the computer system can implement methods and techniques described below to generate a connectivity fingerprint based on the remaining devices connected to the wireless access point. Therefore, in this example, the computer system accesses identifiers of fixed devices within the space and excludes these devices from the set of wireless connectivity data, such that the remaining wireless connectivity data represents mobile devices (e.g., devices carried by a human) within the space.

In another example, the computer system can identify a set of fixed devices based on identifying identifiers associated with the set of fixed devices in the set of wireless connectivity data according to a particular frequency exceeding a threshold frequency.

In particular, the computer system can, for a set of time periods: access wireless connectivity data representing a set of devices connected to a wireless network during a first time period; identify a first device identifier in the wireless connectivity data representing a first device in the set of devices during the first time period; access wireless connectivity data representing a second set of devices connected to the wireless network during a second time period; identify the first device identifier in the wireless connectivity data representing the first device in the set of devices during the second time period; and, in response to detecting the first device identifier during the first time period and the second time period, identify the first device as a fixed device within the space.

Accordingly, in this example, the computer system can identify a particular device identifier, for a particular device, in wireless connectivity data over periods of time according to a particular frequency; and, in response to the particular frequency of identifying the particular device identifier exceeding a threshold frequency, identify (e.g., label) the particular device as a fixed device within the space and exclude the first device identifier from the set of wireless connectivity data.

Therefore, in this example, the computer system identifies fixed devices within the space based on a frequency of these devices connecting to the wireless network, and excludes these devices from the set of wireless connectivity data, such that the remaining wireless connectivity data represents mobile devices (e.g., devices carried by a human) within the space.

### 10.2 Connectivity Fingerprint Congruence

In one implementation, the computer system can, for the first time period: access a first set of wireless connectivity data representing a first set of mobile devices connected to a first wireless access point, deployed within the space, during the first time period; construct a first connectivity fingerprint for the work zone based on the first set of wireless connectivity data; and associate the first occupancy bias function with the first connectivity fingerprint. In this example, the computer system can further, for a second time period: access a second set of wireless connectivity data representing a second set of mobile devices connected to the first wireless access point during the second time period; and construct a second connectivity fingerprint for the work zone based on the second set of wireless connectivity data. In this example, the computer system can correct the second uncorrected occupancy count according to the first occupancy bias function by: selecting the first occupancy bias function based on correspondence between first connectivity fingerprint and the second connectivity fingerprint; and applying the first occupancy bias function to the second uncorrected occupancy count to correct the second uncorrected occupancy count.

Accordingly, in this implementation, the computer system can select a pre-calculated bias function for a particular time period based on correspondence between distribution of mobile devices for the target time period and a previous time period rather than recalculating a (new) bias function for a (new) time period.

### 10.3 Connectivity Fingerprint Divergence

In one implementation, the computer system can implement methods and techniques as described herein to: construct a first connectivity fingerprint for a first time and a second connectivity fingerprint for a second time period; and construct a first connectivity fingerprint for a third time. In this example, for the third time period, the computer system can, in response to detecting correspondence between the third meeting fingerprint and the first meeting fingerprint in Block S176 of the method, derive a third corrected occupancy count for the work zone at a third target time, during the third time period, based on: the third set of entry events; the third set of exit events; and the first occupancy bias function. The computer system can then, proximal the third target time, update the representation of the work zone, in the visualization of the space rendered on the display, according to the third corrected occupancy count.

In another example, the computer system can implement methods and techniques as described herein to: construct a first connectivity fingerprint for a first time and a second connectivity fingerprint for a second time period; and construct a third connectivity fingerprint for a third time. In this example, the computer system can further: detect a difference (e.g., deviation) between the third connectivity fingerprint and the first connectivity fingerprint in Block S178 of the method; in response to the difference exceeding a threshold difference, access a second baseline occupancy count for the third target time; derive a second occupancy bias function for the work zone based on a difference between the third uncorrected occupancy count and the second baseline occupancy count; and associate the second occupancy bias function with the third connectivity fingerprint.

In this example, the computer system: corrects the third uncorrected occupancy count according to the second occupancy bias function to calculate a third corrected occupancy count for the work zone at the third target time; and, proximal the third target time, updates the representation of the work zone, in the visualization of the space rendered on the display, according to the third corrected occupancy count.

Furthermore, in this example, the computer system can implement methods and techniques as described herein to derive a fourth uncorrected occupancy count and construct a fourth connectivity fingerprint for a fourth time period. The computer system can then: select the second occupancy bias function based on correspondence between the third connectivity fingerprint and the fourth connectivity fingerprint; correct the fourth uncorrected occupancy count according to the second occupancy bias function to calculate a fourth corrected occupancy count for the work zone at the fourth target time; and, proximal the fourth target time, update the representation of the work zone, in the visualization of the space rendered on the display, according to the fourth corrected occupancy count.

Therefore, the computer system can: recalculate an occupancy bias function for the target time period based on lack of correspondence between distribution of mobile devices for the target time period and any previous time period for which an occupancy bias function was calculated.

### 10.4 Wireless Data Sampling

In one implementation, during a sampling period (e.g., once per ten-minute interval, once per one-hour interval when the radio records a radio signal), a population of wireless access points (e.g., wireless sensors) can monitor network traffic (e.g., radio signals) between computing devices (e.g., mobile devices) connected to the network settings of the facility, extract data packets from these radio signals, and transmit these data packets to the computer system.

More specifically, for each sampling period, the wireless access point can: extract data packets from each radio signal, estimate a geospatial location of each radio signal, and extract a device identifier associated with each radio signal. Furthermore, the wireless access point can annotate theses data packets with a timestamp, a location, and the device identifier (e.g., an UUID, a MAC address, an IP address, or other wireless address) pertaining to a mobile device and transmit these annotated data packets to the computer system, such as via a wired or wireless connection (e.g., via a local gateway).

### 11. Calendar Fingerprinting

Generally, the computer system can associate an occupancy bias function for a particular time period with a distribution of meetings scheduled within the work zone during that time period, such as based on a conference room calendar and/or scheduler.

In particular, the computer system can, for a particular time period: access a set of meeting data representing a set of meetings within the work zone, such as from a calendar and/or scheduler associated with the work zone in Block S180 of the method; construct a meeting fingerprint for the work zone based on information (e.g., attendee count, meeting density) associated with the set of meetings in Block S182 of the method; and associate the fingerprint with an occupancy bias function associated with the particular time period in Block S184 of the method.

In one implementation, the computer system can: access an attendee count for each meeting in a set of meetings scheduled for a conference room, such as via a conference room scheduler, during a first time period (e.g., a workday); and aggregate attendee count into an estimated occupancy density throughout the day to derive the meeting fingerprint.

In another implementation, the computer system can, for the first time period: access a first set of meeting data, representing meetings scheduled within the work zone during the first time period; construct a first meeting fingerprint for the work zone based on the first set of meeting data; and associate the first occupancy bias function with the first meeting fingerprint. The computer system can then, for the second time period: access a second set of meeting data, representing meetings scheduled within the work zone during the second time period; and construct a second meeting fingerprint for the work zone based on the second set of meeting data. In this implementation, the computer system can correct the second uncorrected occupancy count according to the first occupancy bias function including: selecting the first occupancy bias function based on correspondence between first meeting fingerprint and the second meeting fingerprint in Block S186 of the method; and applying the first occupancy bias function to the second uncorrected occupancy count to correct the second uncorrected occupancy count.

In a similar implementation, the computer system can implement methods and techniques as described herein to: construct a first meeting fingerprint for a first time and a second meeting fingerprint for a second time period; and construct a third meeting fingerprint for a third time.

In this implementation, the computer system can further: detect correspondence between the third meeting fingerprint and the first meeting fingerprint; derive a third corrected occupancy count for the work zone at a third target time, during the third time period, based on the third set of entry events, the third set of exit events, and the first occupancy bias function; and, proximal the third target time, update the representation of the work zone, in the visualization of the space rendered on the display, according to the third corrected occupancy count.

### 12. Autonomous Human Count Recalibration+Absence of Baseline Count

In one implementation, the computer system can: track absence of humans within the space over a period of time (e.g., one day, one week, one month); retrieve human count biases for regions in the space during this time period; and derive and learn recalibration prediction models to generate a recalibration frequency to return the human count to a baseline count, such as a null quantity of humans, in each region (e.g., return the human count to a baseline count once per hour or once per ten-minute interval) in order to reduce the human count bias for each region.

Furthermore, the computer system can return the human count to the baseline count for each region according to the corresponding recalibration frequency during a next time period (e.g., one day, one week). Alternatively, the computer system can transmit a recalibration frequency to each corresponding sensor block and each sensor block can return the human count to the baseline count according to the recalibration frequency during a next time period (e.g., one day, one week).

### 12.1 Modeling: Correction Frequency

In one variation, responsive to absence of a baseline time of day associated with a baseline count for a particular region, the computer system can: track absence of humans within this particular region over a period of time (e.g., one day, one week, one month); retrieve a human count bias for this particular region during this time period;

and derive a correction prediction model to generate a correction frequency-unique to this particular region-to return the human count to a baseline count.

For example, the computer system can: track with absence of humans or absence of motion within a conference room over a period of time, such as one week; detect a frequency of occurrence of common timestamps or time intervals associated with human absence or absence of motion within the conference room during this time period; retrieve a human count bias associated with the conference room; derive a correction prediction model linking the human count bias and the frequency of occurrence of common time intervals; and generate a correction frequency, such as once per two-hour interval, to return the human count to a null quantity of humans to minimize the human count bias for the conference room.

In another variation, the computer system can further access occupancy data (e.g., lighting conditions, maximum occupancies, or scheduled occupancy) for a region in the space. The computer system can then link common time intervals associated with human absence (e.g., recurring absence of humans within a region of the space) and occupancy data associated with this region to derive a correction prediction model for this region. In this variation, the computer system can generate a correction frequency—such as once per 15-minute interval—to return the human count to a baseline count according to the correction prediction model.

Therefore, the computer system can derive and learn a correction prediction model for each discrete region in the space to generate a correction frequency, implemented by the computer system or an individual sensor block, in order to accurately and efficiently return a human count to a null quantity of humans when each region is known to exhibit absence of humans or absence of motion. Additionally, the computer system can access occupancy data to further inform the correction prediction model and generate a correction frequency for each region in the space. The computer system or an individual sensor block can then implement the correction frequency to return the human count to a baseline count-prior to occurrence of a human count bias-for each region in the space.

### 13. Visualization+Occupancy States

Generally, the computer system can dynamically (e.g., in near-real time) update a visual representation of the space to reflect bias-corrected occupancy counts and/or occupancy states for the space and related regions, such as work zones (e.g., conference rooms).

In particular, the computer system can access an occupancy template defining a set of occupancy states for a space, such as: an “occupied with human absent” state associated with a first corrected occupancy count and first target connectivity fingerprint; an “occupied with human present” state associated with a second target corrected occupancy count and a second connectivity fingerprint; and a “vacant” state associated with a third corrected occupancy count and a third target connectivity fingerprint.

In one implementation, for a first time, the computer system can: access a first connectivity fingerprint; derive a first corrected occupancy count based on entry/exit events recorded by a first sensor block and an occupancy bias function associated with the first time and the first sensor block; and, in response to the first connectivity fingerprint approximating the first target connectivity fingerprint, identify the first work zone in the “occupied with human present” state. Then, the computer system can update the visual representation (e.g., graph, scheduler) to indicate the first work zone in the “occupied with human present” state.

For example, the visual representation can define a graphical representation of occupancy counts for the space throughout a time period, such as corrected occupancy counts for each hour during a time period an office is open.

In another example, the visual representation can define a scheduler for a conference room. In this example, the computer system can: detect a null count for a corrected occupancy count for a particular conference room; and update a conference room scheduler to indicate availability (e.g., a “vacant” status) of the conference room.

Therefore, the computer system can associate connectivity fingerprints and/or corrected occupancy counts with particular occupancy states and dynamically update a visual representation of the space to reflect current occupancy counts (e.g., in near real-time) and/or occupancy states to an operator and/or user.

### 14. Work Zone Investigation

In one variation, the computer system can prompt an operator to investigate a work zone in response to detecting a deviation in an occupancy count exceeding a threshold deviation in Block S164 of the method.

In particular, the computer system can: implement methods and techniques described herein to calculate a corrected occupancy count and a connectivity fingerprint based on wireless connectivity data; identify a difference between the corrected occupancy count and an occupancy indicated by the connectivity fingerprint; and, in response to the difference exceeding a threshold difference (e.g., greater than an estimated error) at a first time, prompt an operator to investigate the work zone for a mobile device or a human present in the work zone at the first time.

More specifically, the computer system can: access a first set of wireless connectivity data representing a first set of mobile devices connected to a first wireless access point, deployed within the space, during the second time period; and, in response to the second corrected occupancy count indicating absence of occupancy of the work zone and in response to the first set of wireless connectivity data indicating occupancy of the work zone, prompt an operator to investigate the work zone, such as by investigating for a human present and/or a lost mobile device.

Accordingly, the computer system can enable an operator to identify a non-compliant human and/or lost mobile device by identifying deviations in occupancy counts and/or wireless network data indicating presence of a human and/or mobile device during a pre-determined vacant time period of the space.

### 15. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for tracking objects entering and exiting a work zone within a space, the method comprising:
for a first time period:
accessing a first set of entry events recorded by a first sensor block, deployed within the work zone, during the first time period;
accessing a first set of exit events recorded by the first sensor block during the first time period;
deriving a first uncorrected occupancy count for the work zone at a first target time, during the first time period, based on the first set of entry events and the first set of exit events;
accessing a baseline occupancy count for the first target time; and
deriving a first occupancy bias function for the work zone based on a difference between:
the first uncorrected occupancy count; and
the baseline occupancy count; and
for a second time period:
accessing a second set of entry events recorded by the first sensor block, deployed within the work zone, during the second time period;
accessing a second set of exit events recorded by the first sensor block during the second time period;
deriving a second uncorrected occupancy count for the work zone at a second target time, during the second time period, based on the second set of entry events and the second set of exit events;
correcting the second uncorrected occupancy count according to the first occupancy bias function to calculate a second corrected occupancy count for the work zone at the second target time; and
proximal the second target time, updating a representation of the work zone, in a visualization of the space rendered on a display, according to the second corrected occupancy count.

2. The method of claim 1:
further comprising:
accessing a first set of wireless connectivity data representing a first set of mobile devices connected to a first wireless access point, deployed within the space, during the first time period; and
detecting the target time, during the first time period, characterized by absence of mobile devices connected to the first wireless access point; and
wherein deriving the first uncorrected occupancy count for the work zone at the first target time comprises deriving the first uncorrected occupancy count for the work zone at the first target time:
based on absence of mobile devices connected to the first wireless access point at the target time; and
in response to absence of mobile devices connected to the first wireless access point.

3. The method of claim 2, further comprising selecting the first wireless access point from a set of wireless access points deployed within the space, the first wireless access point located within the work zone and proximal the first sensor block.

4. The method of claim 1:
wherein deriving the first uncorrected occupancy count for the work zone at the first target time comprises deriving the first uncorrected occupancy count for the work zone at the first target time associated with vacancy of the work zone; and
wherein accessing the baseline occupancy count for the first target time comprises accessing the baseline occupancy count comprising a zero-occupancy count.

5. The method of claim 1:
further comprising, at the first target time, prompting an operator to input a manual occupancy count for the work zone;
wherein accessing the baseline occupancy count for the first target time comprises accessing the manual occupancy count input by the operator; and
wherein deriving the first occupancy bias function for the work zone based on the difference between the first uncorrected occupancy count and the baseline occupancy count comprises deriving the first occupancy bias function for the work zone based on the difference between:
the first uncorrected occupancy count; and
the manual occupancy count.

6. The method of claim 1, further comprising:
accessing a first set of wireless connectivity data representing a first set of mobile devices connected to a first wireless access point, deployed within the space, during the second time period; and
in response to the second corrected occupancy count indicating absence of occupancy of the work zone and in response to the first set of wireless connectivity data indicating occupancy of the work zone, prompting an operator to investigate the work zone.

7. The method of claim 1, further comprising, at the first sensor block deployed proximal a threshold of the work zone and comprising a motion sensor:
in response to detecting a first entry event at the threshold of the work zone, recording the first set of entry events during the first time period;
in response to detecting a first exit event at the threshold of the work zone, recording the first set of exit events during the first time period;
accessing a data offload schedule; and
in response to detecting a first offload time according to the data offload schedule, transmitting the first set of entry events and the first set of exit events to a remote computer system.

8. The method of claim 1:
wherein accessing the first set of entry events comprises accessing the first set of entry events recorded by:
the first sensor block deployed at a first location within the work zone in response to detecting a first entry event at the first location; and
a second sensor block deployed at a second location, proximal the first location, within the work zone in response to detecting a second entry event at the second location; and
wherein accessing the first set of exit events comprises accessing the first set of exit events:
recorded by the first sensor block in response to detecting a first exit event at the first location; and
recorded by the second sensor block in response to detecting a second exit event at the second location.

9. The method of claim 1:
further comprising:
for the first time period:
accessing a first set of wireless connectivity data representing a first set of mobile devices connected to a first wireless access point, deployed within the space, during the first time period;
constructing a first connectivity fingerprint for the space during the first time period based on the first set of wireless connectivity data; and
associating the first occupancy bias function with the first connectivity fingerprint; and
for the second time period:
accessing a second set of wireless connectivity data representing a second set of mobile devices connected to the first wireless access point during the second time period; and
constructing a second connectivity fingerprint for the space during the second time period based on the second set of wireless connectivity data; and
wherein correcting the second uncorrected occupancy count according to the first occupancy bias function comprises:
in response to detecting correspondence between first connectivity fingerprint and the second connectivity fingerprint:
associating the first occupancy bias function with the second time period; and
applying the first occupancy bias function to the second uncorrected occupancy count to correct the second uncorrected occupancy count for the second time period.

10. The method of claim 9, further comprising, for a third time period:
accessing a third set of entry events recorded by the first sensor block during the third time period;
accessing a third set of exit events recorded by the first sensor block during the third time period;
deriving a third uncorrected occupancy count for the work zone at a third target time, during the third time period, based on the third set of entry events and the third set of exit events;
accessing a third set of wireless connectivity data representing a third set of mobile devices connected to the first wireless access point, deployed within the space, during the third time period;
constructing a third connectivity fingerprint for the space based on the third set of wireless connectivity data;
detecting a difference between the third connectivity fingerprint and the first connectivity fingerprint;
in response to the difference exceeding a threshold difference:
accessing a second baseline occupancy count for the third target time;
deriving a second occupancy bias function for the work zone based on a difference between:
the third uncorrected occupancy count; and
the second baseline occupancy count; and
associating the second occupancy bias function with the third connectivity fingerprint;
correcting the third uncorrected occupancy count according to the second occupancy bias function to calculate a third corrected occupancy count for the work zone at the third target time; and
proximal the third target time, updating the representation of the work zone, in the visualization of the space rendered on the display, according to the third corrected occupancy count.

11. The method of claim 10, further comprising, for a fourth time period:
accessing a fourth set of entry events recorded by the first sensor block, deployed within the work zone, during the fourth time period;
accessing a fourth set of exit events recorded by the first sensor block during the fourth time period;
deriving a fourth uncorrected occupancy count for the work zone at a fourth target time, during the fourth time period, based on the fourth set of entry events and the fourth set of exit events;
accessing a fourth set of wireless connectivity data representing a fourth set of mobile devices connected to the first wireless access point, deployed within the space, during the fourth time period.
constructing a fourth connectivity fingerprint for the space based on the fourth set of wireless connectivity data;
in response to detecting correspondence between third connectivity fingerprint and the fourth connectivity fingerprint:
selecting the second occupancy bias function; and
correcting the fourth uncorrected occupancy count according to the second occupancy bias function to calculate a fourth corrected occupancy count for the work zone at the fourth target time; and
proximal the fourth target time, updating the representation of the work zone, in the visualization of the space rendered on the display, according to the fourth corrected occupancy count.

12. The method of claim 1:
further comprising:
for the first time period:
accessing a first set of meeting data representing meetings scheduled within the work zone during the first time period;
constructing a first meeting fingerprint for the work zone based on the first set of meeting data; and
associating the first occupancy bias function with the first meeting fingerprint;
for the second time period:
accessing a second set of meeting data, representing meetings scheduled within the work zone during the second time period; and
constructing a second meeting fingerprint for the work zone based on the second set of meeting data; and
wherein correcting the second uncorrected occupancy count according to the first occupancy bias function comprises:
selecting the first occupancy bias function based on correspondence between first meeting fingerprint and the second meeting fingerprint; and
applying the first occupancy bias function to the second uncorrected occupancy count to correct the second uncorrected occupancy count.

13. The method of claim 12:
wherein the work zone comprises a conference room;
wherein accessing the first set of meeting data comprises:
accessing an electronic conference room scheduler associated with the conference room; and
extracting the first set of meeting data from the electronic conference room scheduler, the first set of meeting data comprising a set of attendee counts for meetings scheduled for the work zone during the first time period; and
wherein constructing the first meeting fingerprint for the work zone comprises
constructing the first meeting fingerprint for the work zone based on the set of attendee counts.

14. The method of claim 12, further comprising, for a third time period:
accessing a third set of entry events recorded by the first sensor block during the third time period;
accessing a third set of exit events recorded by the first sensor block during the third time period;
accessing a third set of meeting data representing meetings scheduled within the work zone during the third time period;
constructing a third meeting fingerprint for the work zone based on the third set of meeting data, the third meeting fingerprint approximating the first meeting fingerprint;
deriving a third corrected occupancy count for the work zone at a third target time, during the third time period, based on:
the third set of entry events;
the third set of exit events; and
the first occupancy bias function; and
proximal the third target time, updating the representation of the work zone, in the visualization of the space rendered on the display, according to the third corrected occupancy count.

15. A method for tracking objects entering and exiting a work zone within a space, the method comprising:
for a first time period:
accessing a first set of entry events recorded by a first sensor block, deployed within the work zone, during a first time period;
accessing a first set of exit events recorded by the first sensor block during the first time period;
deriving a first uncorrected occupancy count for the work zone at a first target time, during the first time period, based on the first set of entry events and the first set of exit events;
accessing a first set of wireless connectivity data representing a first set of mobile devices connected to a first wireless access point, deployed within the space, during the first time period; and
in response to a count of mobile devices in the first set of mobile devices indicating a target occupancy in the work zone at a first target time:
accessing a baseline occupancy count for the work zone; and
deriving a first occupancy bias function for the work zone based on a difference between the first uncorrected occupancy count and the baseline occupancy count;
for a second time period:
accessing a second set of entry events recorded by the first sensor block during the second time period;
accessing a second set of exit events recorded by the first sensor block during the second time period;
deriving a second uncorrected occupancy count for the work zone at a second target time, during the second time period, based on the second set of entry events and the second set of exit events; and
correcting the second uncorrected occupancy count according to the first occupancy bias function to calculate a second corrected occupancy count for the work zone at the second target time; and
updating a representation of the work zone, in a visualization of the space rendered on a display, according to the second corrected occupancy count.

16. The method of claim 15:
further comprising:
constructing a first connectivity fingerprint for the space based on the first set of wireless connectivity data;
associating the first occupancy bias function with the first connectivity fingerprint; and
constructing a second connectivity fingerprint for the space based on the second set of wireless connectivity data; and
wherein correcting the second uncorrected occupancy count according to the first occupancy bias function to calculate the second corrected occupancy count for the work zone at the second target time comprises:
correcting the second uncorrected occupancy count according to the first occupancy bias function based on correspondence between the second connectivity fingerprint and the first connectivity fingerprint.

17. The method of claim 15:
wherein accessing the first set of entry events recorded by the first sensor block comprises accessing the first set of entry events recorded by the first sensor block deployed proximal a conference room threshold of a conference room;
wherein correcting the second uncorrected occupancy count according to the first occupancy bias function comprises correcting the second uncorrected occupancy count according to the first occupancy bias function to calculate the second corrected occupancy count comprising a zero-occupancy count indicating a vacant status of the conference room; and
wherein updating the representation of the work zone, in the visualization of the space rendered on the display, according to the second corrected occupancy count comprises updating a scheduler associated with the conference room to indicate the vacant status of the conference room.

18. A method for tracking objects entering and exiting a work zone within a space, the method comprising:
accessing a first set of entry events recorded by a first sensor block, deployed within the work zone, during a first time period;
accessing a first set of exit events recorded by the first sensor block during the first time period;
deriving a first uncorrected occupancy count for the work zone at a first target time, during the first time period, based on the first set of entry events and the first set of exit events;
accessing a first set of wireless connectivity data representing a first set of mobile devices connected to a first wireless access point, deployed within the space, during the first time period;
in response to the first set of wireless connectivity data indicating a target occupancy count at a first target time, deriving a first occupancy bias function for the work zone based on a difference between:
the first uncorrected occupancy count; and
the target occupancy count;
correcting the first uncorrected occupancy count according to the first occupancy bias function to calculate a first corrected occupancy count for the work zone at the first target time; and
proximal the first target time, updating a representation of the work zone, in a visualization of the space rendered on a display, according to the first corrected occupancy count.

19. The method of claim 18, further comprising, for a second time period:
accessing a second set of entry events recorded by the first sensor block, deployed within the work zone, during the second time period;
accessing a second set of exit events recorded by the first sensor block during the second time period;
deriving a second uncorrected occupancy count for the work zone at a second target time, during the second time period, based on the second set of entry events and the second set of exit events;
correcting the second uncorrected occupancy count according to the first occupancy bias function to calculate a second corrected occupancy count for the work zone at the second target time; and
proximal the second target time, updating the representation of the work zone, in the visualization of the space, according to the second corrected occupancy count.

20. The method of claim 18, further comprising:
for the first time period:
constructing a first connectivity fingerprint for the space during the first time period based on the first set of wireless connectivity data; and
associating the first occupancy bias function with the first connectivity fingerprint;
for a second time period:
accessing a second set of entry events recorded by the first sensor block, deployed within the work zone, during the second time period;
accessing a second set of exit events recorded by the first sensor block during the second time period;
deriving a second uncorrected occupancy count for the work zone at a second target time, during the second time period, based on the second set of entry events and the second set of exit events;
accessing a second set of wireless connectivity data representing a second set of mobile devices connected to the first wireless access point during the second time period; and
constructing a second connectivity fingerprint for the space during the second time period based on the second set of wireless connectivity data; and
in response to detecting correspondence between first connectivity fingerprint and the second connectivity fingerprint:
associating the first occupancy bias function with the second time period; and
applying the first occupancy bias function to the second uncorrected occupancy count to correct the second uncorrected occupancy count for the second time period.
